(19) United States
(12) Patent Application Publication
(10) Pub. No.: US 2012/0232751 A1
(43) Pub. Date: Sep. 13, 2012

(54) Pressure-Sensitive Steering Wheel Controls

(76) Inventor: Jorge Guspan, Lake Shastina, CA (US)

(21) Appl. No.: 13/412,545

(22) Filed: Mar. 5, 2012

Related U.S. Application Data
(60) Provisional application No. 61/449,986, filed on Mar. 7, 2011.

(51) Int. Cl. G06F 7/00

(52) U.S. Cl. 701/36; 701/1

(57) ABSTRACT

A vehicle control apparatus, method and system are described. The vehicle control apparatus includes multiple sensing locations adapted to receive input from an operator of the vehicle, each sensing location has a set of sensing elements placed throughout the sensing location, a set of components adapted to evaluate signals produced by the sensing locations, and a set of components adapted to generate at least one output signal that controls operation of a vehicle functionality. The method receives an input signal from a pressure-sensing location, determines whether the input signal matches some criteria, and generates a control output when they match. The system includes an operator input module that receives a control signal based at least partly on pressure applied to locations along a steering control, a verification module that determines whether the received control signal matches some criteria, and an output module that activates at least one vehicle functionality.

### CROSS-REFERENCE TO RELATED APPLICATIONS

This application claims the benefit of U.S. Provisional Application No. 61/449,986, filed on Mar. 7, 2011.

### BACKGROUND

Automotive manufacturers typically provide control mechanisms that may be operated by one of a driver's hands. Such mechanisms may include physical components such as control arms, buttons, and/or twist controls, etc. These mechanisms may be used to control various vehicle functionalities such as activation of turn signals, brightening or dimming headlights, etc.

One difficulty in using existing solutions is that the driver has to remove one or both hands from the steering wheel (or handlebars, joystick, etc.) or keep one or both hands in contact with the wheel in order to operate the control mechanism. In addition, different vehicles may place control mechanisms at different locations and/or use different ways of activating various vehicle functionalities (e.g., some headlights are brightened/dimmed by moving the control mechanism toward the driver and then releasing the mechanism, while some are brightened by moving the control away from the driver and dimmed by moving the control back toward the driver, etc.). Furthermore, the driver's thought processes are interrupted as the driver anticipates the need to remove a hand from the wheel before locating, grasping, and manipulating the control mechanism. These factors can cause drivers to initiate the wrong operation (e.g., activating a turn signal rather than dimming the headlights) or otherwise negatively affect the driver's performance.

For these reasons, there exists a need for a way for drivers to control various vehicle functionalities without releasing control of the steering wheel. In addition, there exists a need for improved ways of receiving driver input that reduce the possibility of activating an unintended functionality.

### BRIEF SUMMARY

For a vehicle control that manages a particular vehicle functionality, some embodiments of the invention may provide a novel apparatus and method that allow an operator to control the particular functionality. In some embodiments, the vehicle control may include one or more arrays of sensing locations for receiving input(s) from an operator. The sensing locations in some of these embodiments may include areas placed at various positions along the steering wheel (or other control apparatus). Different embodiments may use different types and/or placements of sensing locations. For instance, the sensing locations in some embodiments may be composed of discrete sensing points that are arranged within the sensing location. In other embodiments, the sensing locations may be composed of continuous sensing regions that span the area defined by the sensing location. In some embodiments, each sensing location may include a set of one or more sensing modules, for receiving input from the operator by monitoring the output(s) of the sensing module(s).

The sensing modules of some embodiments may be physical components placed at the sensing locations. Each sensing module may include a set of one or more sensing elements. Each sensing element may include a set of one or more sensing devices. In some embodiments, each sensing device may be capable of sensing pressure applied to the device and generating an output signal based on the applied pressure.

In some embodiments, the output signals generated by the sensing devices (and, in turn, the sensing elements, sensing modules, and/or sensing locations) may be used to determine whether to activate various vehicle functionalities. In this manner, each sensing location may control a set of one or more vehicle functionalities. Some embodiments may determine whether to activate a particular functionality based on a comparison between the signal(s) received from the sensing location(s) and some criteria associated with the particular functionality. When the signal(s) match the criteria, the particular functionality may be activated (or otherwise controlled).

Some embodiments may include a system and method for processing the signals generated by the sensing locations, determining whether the received signals match any evaluation criteria associated with a particular functionality, and generating output signals that control (either directly or indirectly) the operation of various vehicle functionalities. The system of some embodiments may include various analog circuitry, digital circuitry, analog-to-digital converters, digital-to-analog converters, power regulation devices, electromechanical controls, mechanical interfaces, and/or other components as appropriate.

The evaluation criteria of some embodiments may include such factors as signal magnitude, signal duration, signal frequency, and/or other similar factors. In addition, some embodiments may perform evaluations that are at least partly digital (e.g., input signals may be evaluated using logical operations or other digital signal processing). Some embodiments may allow an operator to set or change the evaluation criteria. Some embodiments may automatically change the evaluation criteria based on certain driver attributes (e.g., the sensing locations may be automatically adjusted based on seat position, steering wheel position, etc.).

Some embodiments include a vehicle control apparatus that has multiple sensing locations adapted to receive input from an operator of the vehicle, each sensing location comprising a set of sensing elements placed throughout the sensing location, a set of components adapted to evaluate signals produced by the sensing locations, and a set of components adapted to generate at least one output signal that controls operation of a particular functionality of the vehicle.

Some embodiments include a method of controlling various vehicle functionalities using a vehicle control apparatus having pressure-sensing locations, the method includes: receiving an input signal from at least one of the pressure-sensing locations, determining whether the input signal matches a particular evaluation criteria, and generating a vehicle functionality control output when the input signal matches the particular evaluation criteria.

Some embodiments include a system adapted to control vehicle functionalities, the system including: an operator input module adapted to receive a control signal based at least partly on pressure applied to locations along a steering wheel of the vehicle, a verification module adapted to determine whether the received control signal matches an evaluation criteria, and an output module adapted to generate signals capable of activating at least one vehicle functionality when the received control signal matches the evaluation criteria.

The preceding Brief Summary is intended to serve as an introduction to some embodiments of the invention. It is not meant to be an introduction or overview of all inventive subject matter disclosed in this document. The Detailed Description that follows and the drawings that are referred to in the Detailed Description will further describe the embodiments described in the Brief Summary as well as other embodiments. Accordingly, to understand all of the embodiments described by this document, a full review of the Brief Summary, Detailed Description and the drawings is needed. Moreover, the claimed subject matter is not to be limited by the illustrative details in the Brief Summary, Detailed Description and the drawings, but rather is to be defined by the appended claims, because the claimed subject matter can be embodied in other specific forms without departing from the spirit of the invention.

### BRIEF DESCRIPTION OF THE DRAWINGS

For purpose of explanation, several embodiments of the invention are set forth in the following figures.

FIG. 1 illustrates a two-dimensional front view of an example of various arrays of sensing locations as may be used in some embodiments;

FIG. 2 illustrates a perspective view of a sensing module placement at a particular sensing location of a steering wheel as may be used in some embodiments;

FIG. 3 illustrates a schematic diagram of a conceptual system with which some embodiments of the invention may be implemented;

FIG. 4 illustrates a flow chart of a conceptual process that some embodiments may use to operate various operational controls of a vehicle using a set of sensing locations;

FIG. 5 illustrates a flow chart of a conceptual process that some embodiments may use to program or update a control used to activate various vehicle functionalities; and

FIG. 6 illustrates a flow chart of a conceptual process that some embodiments may use to program or change a set of sensing locations used to activate a particular vehicle functionality.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Although several examples above and below describe particular operations, features, etc., one of ordinary skill in the art will recognize that different embodiments may perform different operations, present different features, or otherwise differ from the examples given. For instance, although many operations are described as being performed using a steering wheel, one of ordinary skill in the art will recognize that these operations could also be performed using other types of controls (e.g., handlebars, joysticks, etc.). As another example, the sensing locations may be used for various other purposes than those described below. As yet another example, in some embodiments the sensing locations, in addition to receiving inputs from the operator, may provide feedback to the operator (e.g., by vibrating) to alert the operator to various conditions.

The following terms, as used herein, are defined as follows:

“Operational controls” includes any vehicle functionality that may typically be controlled by an operator in real-time. Examples of operational controls include, but are not limited to, turn signal activation and deactivation, headlight brightening or dimming, windshield wiper activation and speed, and cruise control functions.

An “operator” is any person who is capable of manipulating a vehicle's controls.

A “sensing device” is any electronic or physical device capable of detecting grip pressure. A sensing device may include multiple sub-components, including, but not limited to sensors (e.g., pressure sensors), passive circuitry (e.g., capacitors, resistors, etc.), active circuitry (e.g., transistors, switches, etc.), drive circuitry (e.g., oscillators, voltage sources, etc.), and mechanical features (e.g., levers, contact plates, etc.). Such sub-components may be adjacent or separated, as appropriate.

A “sensing element” is a set of sensing devices.

“Sensing locations” are any locations that may include one or more sensing elements.

A “sensing module” is a set of sensing elements.

A “sensor array” is any particular arrangement of a set of sensing elements.

“Signals” may include analog signals, digital signals, or a combination of analog and digital signals.

A “steering wheel” is any steering control apparatus that can be held and manipulated by a vehicle operator.

A “vehicle” is any means of transportation (whether by land, sea, or air). For instance, a vehicle may be a car, a truck, a motorcycle, a boat, etc.

A “vehicle functionality” includes any and all operations that may be performed by any vehicle component. This includes but is not limited to physical devices such as turn signals and headlights, electronic components such as radios, horns and cruise control systems, and/or any other component that may be controlled by the operator in real-time.

Several more detailed embodiments of the invention are described in the sections below. Section I provides a conceptual description of sensor arrangements used by some embodiments. Next, Section II describes a system used to implement some embodiments of the invention. Section III then describes a method of operation used by some of the embodiments of the invention. Next, Section IV describes a method used by some embodiments to program a control used to activate various vehicle functionalities. Lastly, Section V describes a method used by some embodiments to program a set of sensing locations used to activate a particular vehicle functionality.

### I. Arrangement of Sensing Locations and Devices

Sub-section I.A describes the placement of the various sensing locations. Sub-section I.B then describes the placement of various sensing modules and devices within those sensing locations.

### A. Placement of Sensing Locations

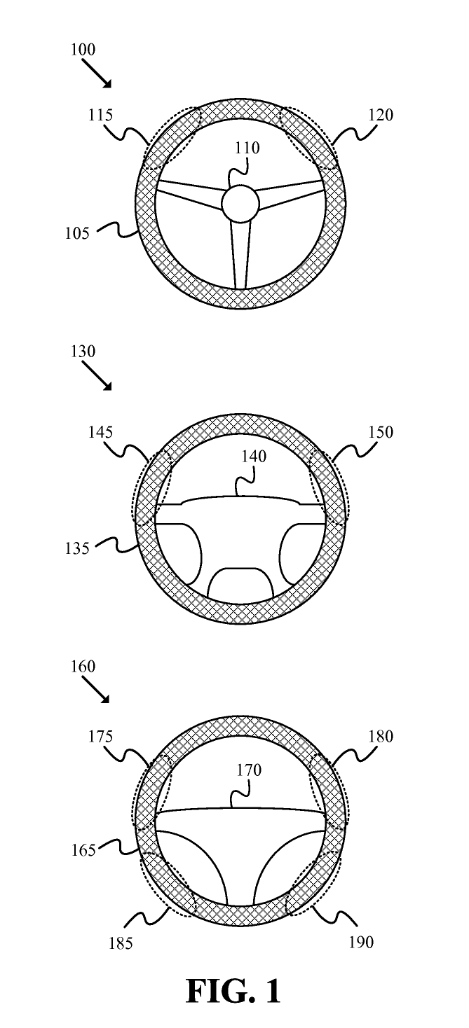

For some embodiments of the invention, FIG. 1 illustrates various arrays of sensing locations. Specifically, this figure illustrates three example steering wheel designs and their associated sensing location placements. As shown in FIG. 1, the first example steering control 100 includes a steering wheel 105, a center section 110, and two sensing locations 115-120. The steering wheel 105 allows a vehicle operator (i.e., a driver) to manipulate a vehicle steering mechanism (not shown), the center section 110 is for coupling the steering wheel to the steering mechanism, and the sensing locations 115-120 are for determining whether pressure is applied to the associated sections along the steering wheel. In this example, the sensing locations 115 and 120 are placed at roughly the “ten o'clock” and “two o'clock” positions, respectively. While an operator positions the steering wheel in the normal course of operating the vehicle, the sensing locations 115-120 monitor the pressure applied in order to determine whether to activate one or more options from a set of operational controls of the vehicle. Such a configuration allows an operator to manipulate the controls associated with the sensing locations to engage or disengage various operational controls without having to release control of the steering wheel.

Alternatively, for some embodiments of the invention, FIG. 1 illustrates other sensing location placements. As shown, the second example steering control 130 includes a wheel 135 similar to the wheel above, an alternative center section 140, and two sensing locations 145-150. In this example, the sensing locations 145 and 150 are placed at roughly the “nine o'clock” and “three o'clock” positions, respectively. As above, while an operator positions the steering wheel in the normal course of operating the vehicle, the sensing locations 145-150 monitor the pressure applied to those locations in order to determine whether to activate one or more of a set of operational controls of the vehicle. In this example configuration, the sensing locations may be desirable based on the effects of airbag deployment on operators (i.e., the “ten and two” position results in burn injuries when an airbag is deployed, so the “nine and three” position may be preferred).

As another example, for some embodiments of the invention, FIG. 1 illustrates other sensing location placements. As shown, the third example steering control 160 includes a wheel 165 similar to those above, a second alternative center section 170, and four sensing locations 175-190. In this example, the sensing locations 175-190 are placed at roughly the “nine o'clock,” “three o'clock,” “four o'clock,” and “eight o'clock” positions, respectively. As above, while an operator positions the steering wheel in the normal course of operating the vehicle, the sensing locations 175-190 may monitor the pressure applied to those locations in order to determine whether to activate or deactivate one or more of a set of operational controls of the vehicle.

In example configuration 160, the operator may access the different sensing locations (or pairs of locations) in order to activate or deactivate different controls. For instance, the top pair of sensing locations 175 and 180 may be used to activate or deactivate some operation while the bottom pair of sensing locations 185 and 190 may be used to activate or deactivate some other operation. As another alternative, the top pair of sensing locations and the bottom pair of sensing locations may both perform the same function, allowing the operator to use different hand positions along the steering wheel.

As one example of using the sensing locations to activate an operational control, an operator may squeeze the steering wheel twice in rapid succession at one of the locations 115, 145, 175 or 185 in order to activate the vehicle's left turn signal. Further, the operator may then squeeze the wheel once at the same location 115, 145, 175 or 185 in order to deactivate the turn signal. In this example, the operator squeezes twice when activating the signal in order to prevent the signal from being activated accidentally during normal use of the wheel. However, one of ordinary skill in the art will recognize that various other ways of achieving a similar result may be used (e.g., by requiring the operator to squeeze and hold for a minimum time to activate the signal, by ignoring any inputs when an operator turns the steering wheel beyond a certain point, etc.).

As another example of using the sensing locations to activate an operational control, an operator may simultaneously squeeze the steering wheel at two locations, such as locations 115 and 120, locations 145 and 150, locations 175 and 180, or locations 185 and 190 in order to activate or deactivate the vehicle's “high-beam” headlights. As above, some filtering or other ways may be used to ensure that the operator does not activate the controls unintentionally (e.g., by squeezing twice to active the high-beams, by having to squeeze and hold for a length of time, etc.).

One of ordinary skill in the art will recognize that while the placement of sensing locations has been described with reference to particular examples, some embodiments may use various other placements without deviating from the spirit of the invention. For instance, the placements may be based on the design of the steering wheel, operator preference, etc. In addition, different embodiments may include different numbers (or types) of sensing locations. For instance, some embodiments may include a number of sensing locations (e.g., two, four, eight, sixteen, thirty-two, one hundred, one thousand, etc.) spaced around the wheel. As another example, some embodiments may include a single sensing location that spans the entire wheel, enabling a change in grip pressure to be detected anywhere along the wheel. Furthermore, although various example operational controls have been described, different embodiments may provide different control options. For instance, the sensing locations could be used to control various interior functions (e.g., climate control, radio, etc.) or other mechanical functions (e.g., activating the vehicle's horn, turning on the vehicle's hazard lights, etc.). Moreover, although the examples refer to sensing locations placed on the steering wheel, such locations could be placed at other locations in or on the vehicle where pressure may be applied by an operator (e.g., on a parking brake lever, a shift lever, a door handle, etc.).

### B. Placement of Sensing Modules, Elements, and Devices

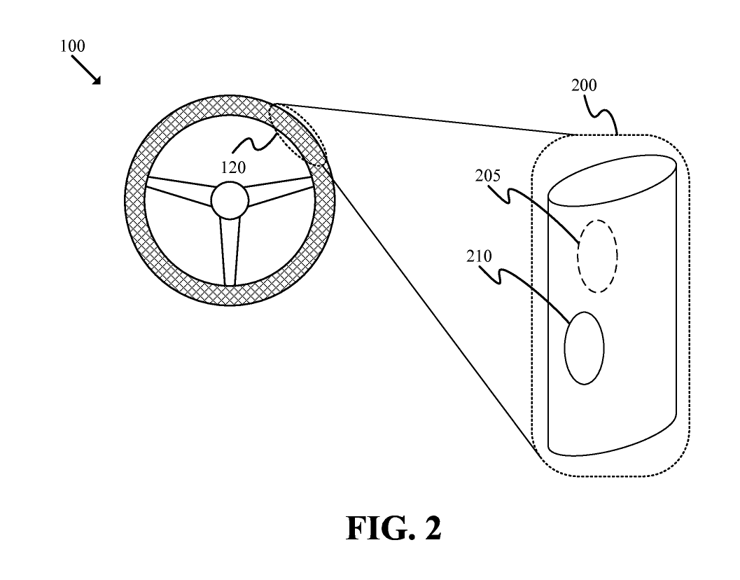

For some embodiments of the invention, FIG. 2 illustrates the placement of a sensing module at a particular sensing location. Specifically, this figure illustrates one example sensing module placement at a particular sensing location 120 of steering wheel 100. As shown in FIG. 2, the sensing location 120, as shown in blow-up section 200, includes a first sensing element 205 and a second sensing element 210. The sensing module may include some or all sensing elements at a particular sensing location. The elements 205-210 may sense an operator's grip pressure, as applied to the associated sections along the steering wheel, and generate an output based on the applied pressure. Each sensing element may include a set of one or more sensing devices (not shown). The sensing devices may be arranged within each sensing element to suit the properties of the sensing devices and/or other design considerations. For instance, the number of sensing devices used at a particular sensing element may depend on the size of the individual sensing devices and the size of the sensing element. As another example, the number of sensing devices may be chosen to minimize power consumption, or otherwise optimize some aspect of performance.

In the example of FIG. 2, the sensing elements 205 and 210 are placed at roughly opposite sides of the steering wheel. While an operator positions the steering wheel in the normal course of operating the vehicle, the sensing elements 205-210 may continuously (and/or discretely) monitor the pressure applied to the sensing devices included in each element (e.g., as applied by the thumb and one or more fingers) in order to determine whether to activate one or more of a set of operational controls of the vehicle. Such a configuration allows an operator to manipulate the controls associated with the sensing points to operate various operational controls without having to release control of the steering wheel.

One of ordinary skill in the art will recognize that the sensing module may be implemented in various different ways without departing from the spirit of the invention. For instance, the module may include more or fewer sensing elements (e.g., one sensing element, a set of two or more sensing elements, etc.) and/or the sensing elements may be arranged in different ways (e.g., six sensing elements may be placed to match the expected positions of an operators thumb and fingers, a matrix of sensing elements may be placed at evenly spaced intervals, etc.). In addition, FIG. 2 is a conceptual representation, and various details have been omitted or represented in a simplified manner for clarity (e.g., various electrical connections to and from the sensing elements are not shown, the individual sensing devices are not shown, etc.). Furthermore, although various physical details have been omitted for brevity and clarity, one of ordinary skill will recognize these physical details may be necessary (e.g., the sensing elements may be encased in some protective material, a physical contact plate or other similar element may be placed over the sensing element, etc.).

### II. System Architecture

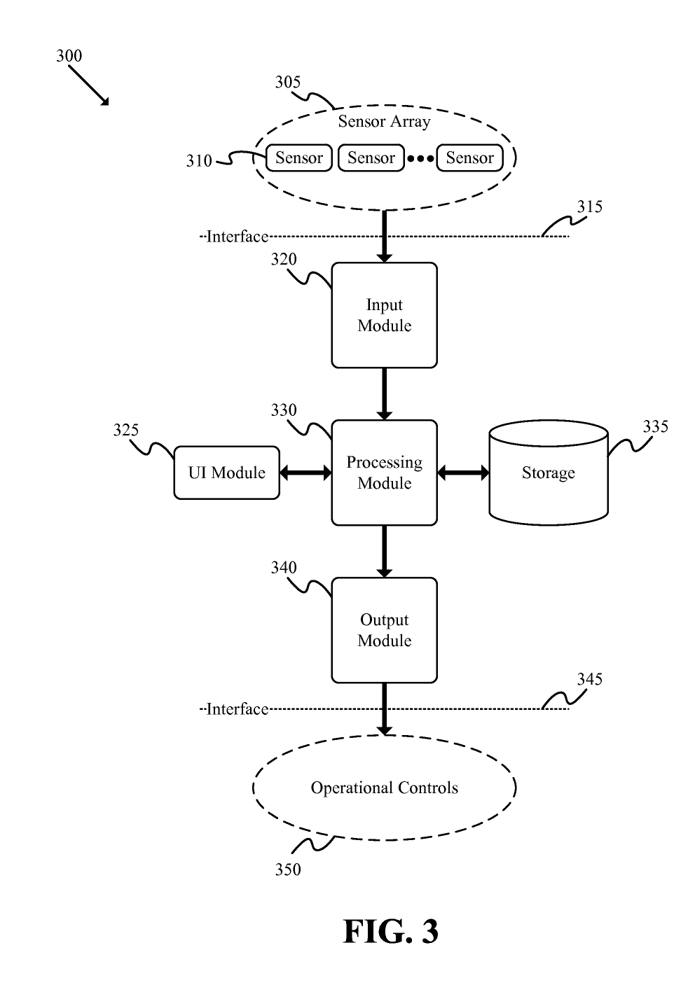

FIG. 3 conceptually illustrates a system 300 with which some embodiments of the invention are implemented. Specifically, this figure illustrates an example of the components involved in receiving a signal from an operator at the steering wheel and transferring that signal to the appropriate operational controls of the vehicle. As shown in FIG. 3, the steering control system 300 includes a sensor array 305 including a set of sensing devices 310, an interface 315, an input module 320, a user interface (UI) module 325, a processing module 330, a storage module 335, an output module 340, another interface 345, and the operational controls of the vehicle 350. The components of the system 300 are electronic and/or mechanical devices that automatically perform operations based on digital and/or analog input signals.

The sensor array 305 may be configured to generate a set of output signals that correspond to the conditions sensed by the array. The sensing devices 310 may form the sensor array, and may be adapted to measure pressure applied at various points along the steering wheel. The interface 315 may receive signals in one format and generate signals in another format. The input module 320 may be adapted to receive, sample, and/or convert sets of external signals and generate a set of outputs based on the received signals. The user-interface (UI) module 325 may allow operators to input and/or review system information. The processing module 330 may retrieve instructions to execute and/or data to process in order to provide the functionality of some embodiments. The storage 335 may be adapted to store instructions and data. The storage may include both read-only storage and read-and-write storage. In addition, the storage may include both volatile and non-volatile memory. The output module 340 may be adapted to receive a set of internal signals and generate a set of output signals based on the received signals. The interface 345 may receive signals in one format and generates signal in another format. The operational controls 350 may allow activation, deactivation, and/or otherwise be adapted to control the operation of various vehicle systems (e.g., headlights, turn signals, etc.). The operational controls may include various combinations of components, including electrical or electronic components, mechanical components, etc.

One of ordinary skill in the art will recognize that the system 300 may be embodied in other specific forms without deviating from the spirit of the invention. For instance, the system may be implemented using various specific devices either alone or in combination. For example, local circuitry (e.g., circuitry placed on or near the steering wheel) may include the interface 315 and input module 320, while remote circuitry (e.g., circuitry placed at one or more locations other than on or near the steering wheel) may include the processing module 330, storage 335 and other components, with the local circuitry connected to the remote circuitry through a communication network (not shown) that the local circuitry accesses through various pathways or connections. Such pathways or connections may include wired, wireless, optical, and/or other types of connections.

The input module 320 may be configured to receive and process signals received from the sensor array 305. Such signals may first pass through one or more interfaces 315 (or, may not pass through any interface at all). Each interface may perform various functions (e.g., stepping a signal level up or down, converting a digital signal from one format to another, etc.). The input module 320 may capture, sample, and or hold the input signals received from the sensor array 305. The input module may also process input signals by converting the signals from one format to another (e.g., from serial to parallel, analog to digital, etc.). The input module then generates output signals that are received by the processing module 330.

The processing module may receive signals from the UI module 325 and the storage module 335 in addition to the input module 320. Different components, modules, integrated circuits (ICs), etc. may perform processing operations, either separately or conjunctively, in different embodiments. For instance, the processing module may include one or more components such as a microprocessor, microcontroller, digital signal processors (DSP), field programmable gate arrays (FPGA), application-specific ICs (ASIC), and/or various other electronic components that may be used for executing instructions (e.g., sets of logic gates, general purpose ICs, etc.).

In some embodiments, the UI module 325 may be able to display information and receive inputs from the user in order to control the functionality provided by the processing module 330. For instance, operators may be able to select various sensing locations and associate those locations with different functions. As another example, operators may be able to activate or deactivate various sensing locations (e.g., by choosing locations that correspond to a “nine and three” driving position rather than a “ten and two” driving position). Such preferences and settings may be saved to storage 335.

The storage (or system memory) may be configured to provide and receive data to and from the processing module 330. Although conceptually represented as a signal module, the storage may include various types of memory, be placed at various locations, and/or be accessible through or by other modules, components, circuitry, and/or communication pathways. The storage module may store some or all of the instructions and data that the processor executes or uses at runtime. In some embodiments, the sets of instructions and/or data used to implement the invention's processes may be stored in the storage. For example, the storage may include instructions for processing sensor signals in accordance with some embodiments.

The output module 340 may be configured to receive signals from the processing module 330 and generates the appropriate output signals for driving the operational controls 350. The signals may be passed through one or more interfaces 345 (or may not pass through any interfaces at all). Interface 345 may perform similar operations to those described above in reference to interface 315.

Some of the functionality and modules described above and below may be implemented as software processes that are specified as sets of instructions recorded on a computer readable storage medium (also referred to as “computer readable medium” or “machine readable medium”). When these instructions are executed by one or more computational element(s), such as processors or other computational elements like ASICs and FPGAs, the instructions may cause the computational element(s) to perform the actions indicated in the instructions. Computer is meant in its broadest sense, and can include any electronic device capable of processing signals. Examples of computer readable media include, but are not limited to, CD-ROMs, flash drives, RAM chips, hard drives, EPROMs, etc. The computer readable media do not include carrier waves and/or electronic signals passing wirelessly or over a wired connection.

In this specification, the term “software” includes firmware residing in read-only memory or applications stored in magnetic storage which can be read into memory for processing by one or more processors. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described herein is within the scope of the invention. In some embodiments, the software programs when installed to operate on one or more computer systems define one or more specific machine implementations that execute and perform the operations of the software programs.

Moreover, while the examples shown illustrate many individual modules as separate blocks (e.g., the input module 320, the output module 340, etc.), one of ordinary skill in the art would recognize that some embodiments might combine these modules into a single functional block or element. One of ordinary skill in the art would also recognize that some embodiments might divide a particular module into multiple modules. In addition, one of ordinary skill in the art would recognize that the modules could be arranged in different ways, use different communication pathways, and/or communicate with other modules (not shown) without departing from the spirit of the invention. In addition, FIG. 3 is a conceptual representation, and various details have been omitted or represented in a simplified manner for clarity (e.g., the sensors 310 would typically require some associated drive circuitry, the various modules may be connected by a bus, the system may include multiple sensor arrays, etc.).

### III. Method of Operation

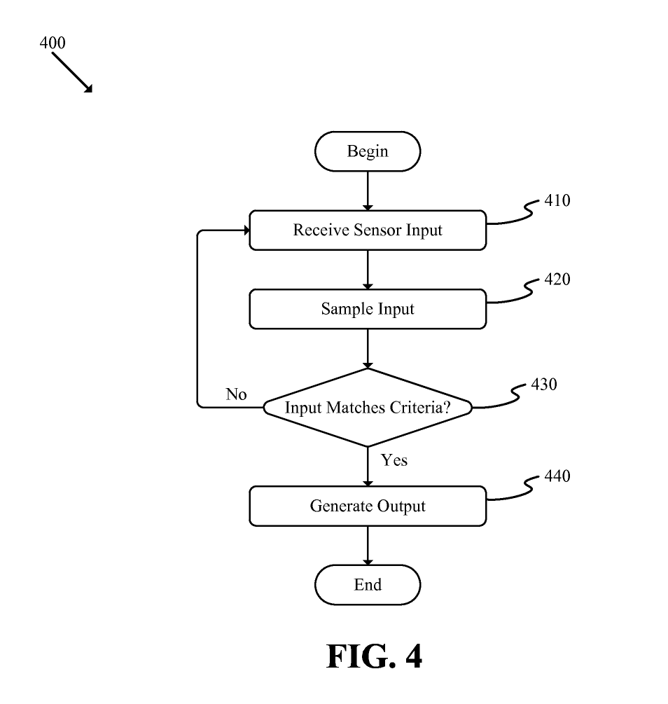

As described above, in some embodiments the activation of a sensing location along a steering wheel (e.g., by squeezing that location) may cause one or more operational controls to be activated or deactivated (e.g., turn signals or high beams). FIG. 4 conceptually illustrates an example of a process 400 that some embodiments use to operate various operational controls of a vehicle using a set of sensing locations. Process 400 will be described by reference to FIGS. 1-3 which illustrate various example sensing locations, sensing modules and devices, and an example system for processing signals generated by the sensing modules.

Process 400 begins when a vehicle with one or more steering wheel sensing locations is turned on. Next, the process receives (at 410) a sensor input (i.e., a signal from one or more sensing devices placed among the sensing locations). Such an input signal could be generated, for example, when an operator squeezes a location, such as those described above in reference to FIG. 1. The signal may be produced by one or more sensing devices (e.g., devices 205 or 210 described above in reference to FIG. 2) that are included in a sensing module (e.g., the module shown in section 200 described above in reference to FIG. 2). As described above in reference to FIG. 3, the signal may pass through one or more interfaces 315 before arriving at the input module 320.

The process then samples the input (at 420). The sampling may involve holding an analog signal level, performing an analog-to-digital conversion, receiving a digital signal, and/or some other way of capturing the state of the sensor input received at 410. In addition, various processing algorithms and/or filter circuitry may be applied to the input. In some embodiments, the input sample may be stored for further processing. Such sampling (and filtering, signal processing, etc.) may be performed by a module such as input module 320 described above in reference to FIG. 3.

Next, process 400 determines (at 430) whether the input matches any evaluation criteria. Such evaluation criteria may include, for instance, one or more locations being squeezed, one or more locations being squeezed twice in succession, pressure being applied to one or more locations for a certain length of time, etc. When the input matches the criteria, the process may generate (at 440) an output, otherwise the process returns to operation 410.

The determination (at 430) may be performed by a module such as the processing module 330 described above in reference to FIG. 3. The processing module may compare the input received from the input module 320 to evaluation criteria received from storage 335. The output generated (at 440) may include providing a digital or analog output signal. In some embodiments, a default output may be generated when no match is found between the input and the evaluation criteria (e.g., a “non-matching” output signal may be generated whenever the input does not match the evaluation criteria). The output signal may be generated by a module such as the output module 340 described above in reference to FIG. 3 based on signals received from the processing module 330.

Some embodiments may repeat process 400 at regular intervals (e.g., based on a number of operational cycles, based on a certain time limit, etc.). Other embodiments may perform process 400 only based on some initiation criteria (e.g., based on receiving an interrupt or other signal that indicates that in input is available). Some embodiments may continuously perform process 400, or portions thereof.

One of ordinary skill in the art will recognize that the operations of process 400 are conceptual and may not necessarily be performed in the order shown. For instance, in some embodiments, the process may first generate a no-signal output before receiving any input. Furthermore, different specific operations may be performed in different embodiments. For instance, some embodiments may further process output signals in order to interface those signals with physical components of the vehicle (e.g., the headlights). The process may also include additional operations. For instance, in some embodiments, the output generated at 440 will receive further processing before being passed to various mechanical (or other) interfaces (e.g., a digital or analog signal may be transformed into a hydraulic pressure, a physical connection, etc.).

The process may not be performed as one continuous series of operations in some embodiments. In addition, the process may be implemented using several sub-processes, or as part of a larger macro-process in some embodiments. Furthermore, various processes may be performed concurrently, sequentially, or some combination of sequentially and concurrently (e.g., certain operations of a first process may be performed concurrently with certain operations of a second process, while other operations of the first process may need to be completed before continuing to other operations of the second process).

### IV. Programming Activation Controls

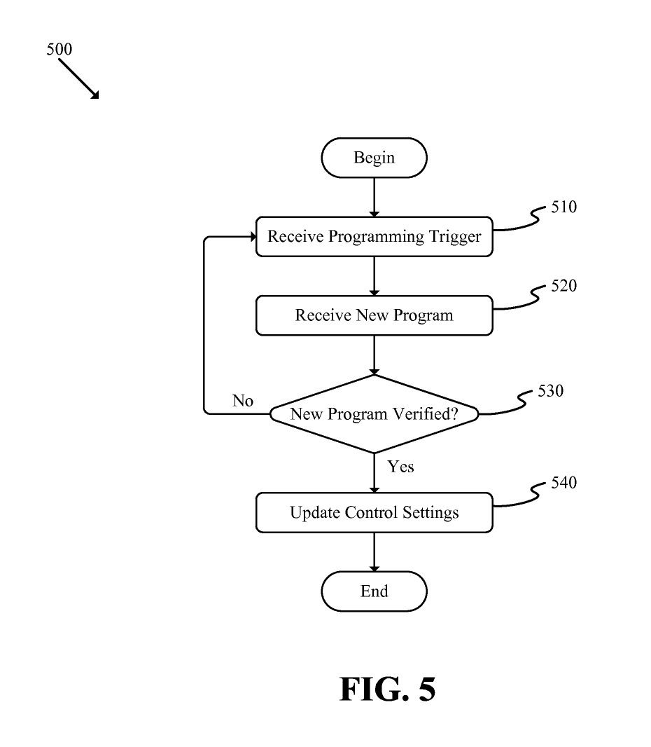

FIG. 5 illustrates a flow chart of a conceptual process 500 that some embodiments may use to program or update controls (e.g., amount or location of pressure) used to activate various vehicle functionalities. Similar to process 400 described above in reference to FIG. 4, process 500 may be implemented using features described above in reference to FIGS. 1-3 which illustrate various example sensing locations, sensing modules and devices, and an example system for processing signals generated by the sensing modules.

Process 500 may begin when a vehicle with one or more steering wheel sensing locations is turned on. Next, the process may receive (at 510) a programming trigger from an operator to initiate a “new program” mode. Such a trigger may be generated in various appropriate ways (e.g., pressing a new program button, applying pressure to a set of sensing locations for a minimum duration of time, etc.). The new program mode may allow the operator to program the controls used to activate vehicle functions that are operable from various sensing locations on the steering wheel.

Next, process 500 may receive (at 520) a new program. After initiating new program mode, the operator may generate input signals to program, for example, the control used to activate a vehicle functionality, which vehicle functionality will be activated, etc. An operator, for example, may want to activate the right hand turn signal by squeezing the right side of the steering wheel twice. A new program for activation of a right turn signal at the sensing location(s) at two o'clock on the steering wheel, for example, may be received when an operator, after initiating new program mode, squeezes the sensing location at two o'clock on the steering wheel twice in succession. In addition, a new program for activation of high beams, for example, may be received when an operator, after initiating new program mode, simultaneously squeezes sensing locations at ten o'clock and two o'clock on the steering wheel for a certain length of time (e.g., at least five seconds).

Next, process 500 may verify (at 530) that the received new program is correct and/or valid. An operator may be able to test operation of the new program (e.g., by attempting to turn on the right turn signal by squeezing the sensing location at two o'clock on the steering wheel twice in succession) before verifying that the newly programmed controls operate as desired. Such verification may be performed in various appropriate ways. The operator may, for instance, perform a similar operation to that used to enter programming mode (e.g., pressing a button, squeezing a location for a minimum duration, etc.).

After a desired vehicle function has been verified, process 500 may update (at 540) the control settings and may exit new program mode. The newly programmed control setting may then be used during normal operation. After updating (at 540) the control settings, the process may end.

One of ordinary skill in the art will recognize that the operations of process 500 are conceptual and may not necessarily be performed in the order shown. For instance, in some embodiments, the process may be configured to require additional input signals to program triggers for deactivating vehicle functionalities. The process may also include additional operations. For instance, in some embodiments, the new program received at 530 may receive further processing before being verified.

The process may not be performed as one continuous series of operations in some embodiments. In addition, the process may be implemented using several sub-processes, or as part of a larger macro-process in some embodiments. Furthermore, various processes may be performed concurrently, sequentially, or some combination of sequentially and concurrently (e.g., certain operations of a first process may be performed concurrently with certain operations of a second process, while other operations of the first process may need to be completed before continuing to other operations of the second process).

### V. Programming Location and Function of Sensing Locations

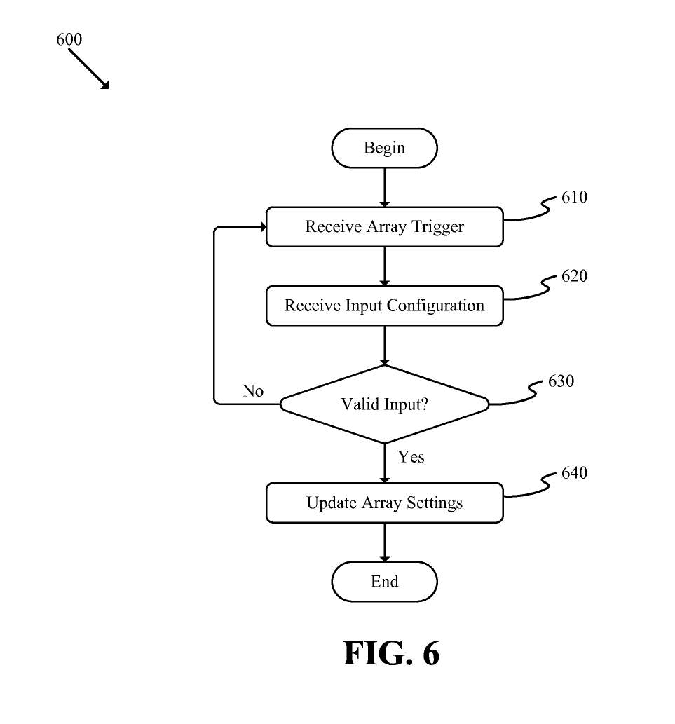

FIG. 6 illustrates a flow chart of a conceptual process 600 that some embodiments may use to program or change a set of sensing locations used to activate a particular vehicle functionality. In some embodiments, process 600 may be included as a sub-process of process 500 (i.e., programming a function and location of a sensing device may be done simultaneously). Similar to processes 400 and 500 described above in reference to FIGS. 4-5, process 600 may be implemented using features described above in reference to FIGS. 1-3 which illustrate various example sensing locations, sensing modules and devices, and an example system for processing signals generated by the sensing modules.

Different operators, for example, may want the same vehicle operation to be activated using different sensing locations on a vehicle steering wheel (e.g., an operator may want the right turn signal to be activated by squeezing the sensing location at two o'clock on the steering wheel while another operator may want the same vehicle operation to be activated by squeezing the sensing location at four o'clock on the steering wheel).

Process 600 may begin when a vehicle with one or more steering wheel sensing locations is turned on. Next, the process may receive (at 610) an array trigger from the operator to cause the system to enter “new array” mode (similar to a new program mode described above in reference to process 500). The new array mode may allow the operator to change which sensing locations control certain vehicle functionalities (e.g., the operator may move the trigger for activation for high beams from six o'clock to twelve o'clock on the steering wheel). Such a trigger may be generated in various appropriate ways (e.g., pressing a new array button, applying pressure to a set of sensing locations for a minimum duration of time, performing a specific action after entering new program mode, etc.). The new array mode may allow the operator to program the locations used to activate vehicle functions that are operable from various sensing locations on the steering wheel.

Next, process 600 may receive (at 620) an input configuration. Once the system of some embodiments initiates new array mode, the operator may generate input signals to change the location on the steering wheel of a sensing location that operates a certain vehicle functionality. Such input signals may be produced, for example, when the operator applies pressure (e.g., squeezes in succession, applies pressure for a certain length of time, etc.) to a location on the steering wheel that the operator wants to change such that a function associated with that location is moved to a different location (or a previously unused location may be selected for association with a function).

The operator, for example, may grip the sensing location at six o'clock, which may have been previously programmed to operate the windshield wipers, for a certain period of time (i.e., five seconds). After the operator applies pressure to the sensing location at six o'clock for five seconds, the function of that sensing location may be moved to a sensing location at, for example, twelve o'clock on the steering wheel. This movement may be produced, for example, by the driver releasing the grip from the six ‘o’ clock position and then gripping the sensing location at twelve o'clock for a certain period of time (i.e., five seconds). These functions may also be changed by applying different types of pressure to the sensing locations (i.e., instead of gripping the sensing location for five seconds, the operator may squeeze the sensing location twice).

Next, process 600 may verify (at 630) that the received input configuration is correct and/or valid. An operator may be able to test operation of the new configuration (e.g., by attempting to activate the windshield wipers using the twelve o'clock location) before verifying that the newly programmed input configuration operates as desired. Such verification may be performed in various appropriate ways. The operator may, for instance, perform a similar operation to that used to enter programming mode (e.g., pressing a button, squeezing a location for a minimum duration, etc.).

After a desired input configuration has been verified, process 600 may update (at 640) the array settings and may exit new array mode. The newly programmed input configuration settings may then be used during normal operation. After updating (at 640) the input configuration settings, the process may end.

One of ordinary skill in the art will recognize that the operations of process 600 are conceptual and may not necessarily be performed in the order shown. For instance, in some embodiments, the process may be configured to require additional input signals to program sensor locations for deactivating vehicle functionalities. The process may also include additional operations. For instance, in some embodiments, the new input configuration received at 630 may receive further processing before being verified.

The process may not be performed as one continuous series of operations in some embodiments. In addition, the process may be implemented using several sub-processes, or as part of a larger macro-process in some embodiments. Furthermore, various processes may be performed concurrently, sequentially, or some combination of sequentially and concurrently (e.g., certain operations of a first process may be performed concurrently with certain operations of a second process, while other operations of the first process may need to be completed before continuing to other operations of the second process).

While the invention has been described with reference to numerous specific details, one of ordinary skill in the art will recognize that the invention can be embodied in other specific forms without departing from the spirit of the invention. For example, several embodiments were described above by reference to particular features and/or components. However, one of ordinary skill in the art will realize that other embodiments might be implemented with other types of features and components. Moreover, one of ordinary skill in the art would understand that the invention is not to be limited by the foregoing illustrative details, but rather is to be defined by the appended claims.

I claim:

1. A vehicle control apparatus comprising:
a plurality of sensing locations adapted to receive input from an operator of the vehicle, each sensing location comprising a set of sensing elements placed throughout the sensing location;
a set of components adapted to evaluate signals produced by the sensing locations; and
a set of components adapted to generate at least one output signal that controls operation of a particular functionality of the vehicle.

2. The vehicle control apparatus of claim 1, wherein the output signal is generated if the signals produced by the sensing locations match a set of evaluation criteria.

3. The vehicle control apparatus of claim 1, wherein:
the vehicle is one of a car, a truck, a motorcycle, a bus, and a boat, and
the control apparatus is one of a steering wheel, handlebars, and joystick.

4. The vehicle control apparatus of claim 1, wherein each sensing element comprises a set of pressure-sensing devices.

5. The vehicle control apparatus of claim 4, wherein:
the vehicle is a car,
the control apparatus includes a steering wheel, and
the plurality of sensing locations includes a location at ten o'clock and a location at two o'clock on the steering wheel.

6. The vehicle control apparatus of claim 5, wherein the particular functionality includes operation of a left turn signal and a right turn signal.

7. The vehicle control apparatus of claim 6, wherein:
the left turn signal is activated when the location at ten o'clock senses pressure twice in succession,
the left turn signal is deactivated when the location at ten o'clock senses pressure once,
the right turn signal is activated when the location at two o'clock senses pressure twice in succession, and
the right turn signal is activated when the location at two o'clock senses pressure once.

8. A method of controlling various vehicle functionalities using a vehicle control apparatus having pressure-sensing locations, the method comprising:
receiving an input signal from at least one of the pressure-sensing locations;
determining whether the input signal matches a particular evaluation criteria; and
generating a vehicle functionality control output when the input signal matches the particular evaluation criteria.

9. The method of claim 8, wherein the particular evaluation criteria includes pressure sensed at a particular sub-set of the pressure-sensing locations.

10. The method of claim 8, wherein the input signal is received when at least one of the pressure-sensing locations senses pressure applied by an operator of the vehicle.

11. The method of claim 8, wherein the vehicle functionality control output at least partly controls the operation of a set of turn signals of the vehicle.

12. The method of claim 8, wherein the vehicle functionality control output at least partly controls the operation of a set of headlights of the vehicle.

13. The method of claim 8, wherein the vehicle functionality control output includes an activation signal.

14. The method of claim 8, wherein the vehicle functionality control output includes a deactivation signal.

15. A system adapted to control vehicle functionalities, the system comprising:
an operator input module adapted to receive a control signal based at least partly on pressure applied to locations along a steering wheel of the vehicle;
a verification module adapted to determine whether the received control signal matches an evaluation criteria; and
an output module adapted to generate signals capable of activating at least one vehicle functionality when the received control signal matches the evaluation criteria.

16. The system of claim 15, wherein the operator input module includes a set of pressure sensors placed along the steering wheel.

17. The system of claim 15, wherein the verification module comprises a processor.

18. The system of claim 15, wherein the at least one vehicle functionality includes operation of at least one turn signal of the vehicle.

19. The system of claim 15, wherein the at least one vehicle functionality includes operation of a set of headlights of the vehicle.

20. The system of claim 15, wherein the locations along the steering wheel are programmable.
